(19) United States
(12) Patent Application Publication
(10) Pub. No.: US 2026/0018795 A1
(43) Pub. Date: Jan. 15, 2026

(54) RADIO FREQUENCY ANTENNA INCLUDING A DIELECTRIC WITH A LOW IN-FILL DENSITY AND ADDITIVE MANUFACTURING METHODS THEREFORE

(71) Applicant: NXP USA, INC., AUSTIN, TX (US)

(72) Inventors: Zhiwei Gong, Chandler, AZ (US); Scott M Hayes, Chandler, AZ (US); Michael B. Vincent, Chandler, AZ (US); Namrata Kanth, Mesa, AZ (US)

(21) Appl. No.: 18/772,526

(22) Filed: Jul. 15, 2024

(51) Int. Cl. H01Q 9/04; H01Q 1/22; H01Q 15/02

(52) U.S. Cl. CPC H01Q 9/0457; H01Q 1/2283; H01Q 15/02

(57) ABSTRACT

An antenna circuit may include a dielectric structure including a first surface; a second surface. and a plurality of laminae extending between the first surface and the second surface. Each lamina may include at least one thickness parameter, at least one slant parameter defining an angle between each lamina and one or more of the first surface or the second surface, and at least one pitch parameter defining an air gap between each lamina and one or more adjacent laminae. Each lamina is configured at least partially overlap the one or more adjacent laminae in a direction that is perpendicular to the first and second surfaces. The antenna circuit may include a first patch antenna disposed on the first surface. The dielectric structure may provide a selected effective permittivity for radio frequency signals from the first patch antenna in the direction that is perpendicular to the first and second surfaces.

### FIELD OF USE

The present disclosure generally relates to circuit devices including a radio frequency antenna, and more particularly, to devices and methods of producing a radio frequency antenna including a dielectric with a low in-fill density, which may be produced using an additive manufacturing technique (such as three-dimensional printing).

### BACKGROUND

When a dielectric is produced that has low in-fill density, the effective permittivity can be lower than the bulk dielectric material, which can reduce transmission loss when used for radio frequency antennas. However, conventional dielectric structures (bulk material and air content) may present a non-uniform structure that can adversely impact radio frequency signals.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures and in the detailed description indicates similar or identical items or features.

FIG. 1A depicts cross-sectional view of a portion of a substrate-based antenna device including a low in-fill dielectric structure formed from slanted laminae, in accordance with one or more embodiments.

FIG. 1B depicts a top view of a portion of a substrate-based antenna device of FIG. 1A including dotted lines indicating overlap regions of the slanted laminae, in accordance with one or more embodiments.

FIG. 2A depicts a cross-sectional view of a portion of the low in-fill dielectric structure including slanted laminae separated by air gaps, in accordance with one or more embodiments.

FIG. 2B depicts a cross-sectional view of a portion of the low in-fill dielectric structure including slanted laminae separated by air gaps, in accordance with one or more embodiments.

FIG. 3A depicts a cross-sectional view of a portion of the low in-fill dielectric structure including slanted laminae with a maximum laminar slant angle and minimum pitch size, in accordance with one or more embodiments.

FIG. 3B depicts a graph of effective permittivity ε′ versus laminar slant angle α, in accordance with one or more embodiments.

FIG. 4A depicts a cross-sectional view of a portion of the low in-fill dielectric structure including slanted laminae having a selected laminar slant angle and a selected laminar thickness, in accordance with one or more embodiments.

FIG. 4B depicts a cross-sectional view of a portion of the low in-fill dielectric structure including slanted laminae with a selected laminar thickness and a selected slant angle, in accordance with one or more embodiments.

FIG. 5A depicts a cross-sectional view of a portion of the low in-fill dielectric structure including slanted laminae with a maximum thickness tₘₐₓ and a pitch size p′, in accordance with one or more embodiments.

FIG. 5B depicts a graph of effective permittivity ε′ versus laminar thickness t, in accordance with one or more embodiments.

FIG. 6A depicts a cross-sectional view of a portion of the low in-fill dielectric structure including slanted laminae having a selected laminar slant angle α and a selected laminar thickness t, in accordance with one or more embodiments.

FIG. 6B depicts a cross-sectional view of a portion of the low in-fill dielectric structure including slanted laminae with a selected slant angle α and a selected laminar thickness t, in accordance with one or more embodiments.

FIG. 7A depicts a graph of effective permittivity ε′ versus laminar thickness t and slant angle α, in accordance with one or more embodiments.

FIG. 7B depicts a table showing the effective permittivity ε′ change with slant angle α and laminar thickness t, in accordance with one or more embodiments.

FIG. 8A depicts a cross-sectional view of a portion of the low in-fill dielectric structure including slanted laminae having a selected laminar slant angle α, a selected laminar thickness t, a selected air gap size g, and a selected laminar pitch size p to provide a selected effective permittivity ε′, in accordance with one or more embodiments.

FIG. 8B depicts a cross-sectional view of a portion of the low in-fill dielectric structure including slanted laminae with a selected laminar slant angle α, a selected laminar thickness t, a selected air gap size g, and a selected laminar pitch size p to provide a selected effective permittivity ε′, in accordance with one or more embodiments.

FIG. 9A depicts a graph of effective permittivity ε′ versus slant angle α in a working zone, in accordance with one or more embodiments.

FIG. 9B depicts a table showing the effective permittivity ε′ change with slant angle α and laminar thickness t in a working zone, in accordance with one or more embodiments.

FIG. 10A depicts a cross-sectional view of a portion of the low in-fill dielectric structure including slanted laminae having a selected thickness t to provide a selected effective permittivity ε′, in accordance with one or more embodiments.

FIG. 10B depicts a cross-sectional view of a portion of the low in-fill dielectric structure including slanted laminae with a selected thickness t to provide a selected effective permittivity ε′, in accordance with one or more embodiments.

FIG. 11A depicts a graph of effective permittivity ε′ versus laminar thickness t in a working zone, in accordance with one or more embodiments.

FIG. 11B depicts a table showing the effective permittivity ε′ change with varying laminar thickness t in a working zone, in accordance with one or more embodiments.

FIG. 12A depicts a graph of a graph of effective permittivity ε′ versus laminar thickness t and slant angle α in a working zone, in accordance with one or more embodiments.

FIG. 12B depicts a table of the effective permittivity ε′ versus laminar thickness t and slant angle α in a working zone, in accordance with one or more embodiments.

FIG. 13A depicts a cross-sectional view of a portion of the low in-fill dielectric structure including slanted laminae with one or more selected gradients across which one or more of the laminar thickness t or the laminar slant angle α gradually change, in accordance with one or more embodiments.

FIG. 13B depicts a diagram of a gradient index generated using one or more embodiments of the low in-fill dielectric structure with slanted laminae having one or more selected indices, in accordance with one or more embodiments.

FIG. 14A depicts a cross-sectional diagram of a portion of an antenna device including a superstrate over the antenna that is formed from a low in-fill dielectric structure having a uniform dielectric constant, in accordance with one or more embodiments.

FIG. 14B depicts a cross-sectional diagram of a portion of an antenna device including a superstrate over the antenna that is formed from a low in-fill dielectric structure having a dielectric constant that varies according to a gradient index, in accordance with one or more embodiments.

FIG. 15A depicts a cross-sectional view of a portion of an antenna device including a low in-fill dielectric structure formed from slanted laminae with a flat cap layer for antenna placement, in accordance with one or more embodiments.

FIG. 15B depicts a cross-sectional view of a portion of a device including a plurality of laminae having a zig-zag pattern, in accordance with one or more embodiments.

FIG. 16 depicts a diagram of an antenna array including multiple antenna devices having low in-fill dielectric structure laminae having a first slant angle α₁ for a first subset of the antenna devices and having a second slant angle α₂ for a second subset of the antenna devices, in accordance with one or more embodiments.

FIG. 17 depicts a flow diagram of a method of forming an antenna circuit including a low in-fill dielectric structure having selected parameters, in accordance with one or more embodiments.

While implementations are described in this disclosure by way of example, those skilled in the art will recognize that the implementations are not limited to the examples or figures described. Rather, the figures and detailed description thereto are not intended to limit implementations to the form disclosed, but instead the intention is to cover all modifications, equivalents, and alternatives falling within the spirit and scope as defined by the appended claims. The headings used in this disclosure are for organizational purposes only and are not meant to limit the scope of the description or the claims. As used throughout this application, the word “may” is used in a permissive sense (in other words, the term “may” is intended to mean “having the potential to”) instead of in a mandatory sense (as in “must”). Similarly, the terms “include,” “including,” and “includes” mean “including, but not limited to.”

### DETAILED DESCRIPTION

Antennas are generally built on substrates, which may include metal layers and dielectric layers. Additive manufacturing, including three-dimensional (3D) printing, may enable customized in-fill density for dielectric materials for a semiconductor device, such as an antenna circuit. When the dielectric is made with a low in-fill density, the effective permittivity ε′ could be made significantly lower than the bulk material, which lower effective permittivity ε′ can reduce transmission loss when used for radio frequency (RF) applications. In general, the air content of a low in-fill density dielectric structure could result in a low effective permittivity ε′ that is as low as an air cavity antenna, but the effective permittivity ε′ may be easier to customize and may be much less expensive than using glass or other substrate materials, for example, when produced using additive manufacturing. In an example, the air gap and air content in the low in-fill dielectric structure of the antenna structure could provide a lower permittivity ε′ and loss tangent as compared to a uniform dielectric bulk material, and hence may increase the gain of the antenna.

As used herein, the term “low in-fill density dielectric structure” or “low in-fill dielectric structure” refers to a dielectric structure that is constructed with air gaps configured to provide an effective permittivity ε′ that is less than the permittivity e of the bulk printed dielectric material. Since air has a lower dielectric constant than a bulk printed dielectric material, the permittivity of air is less than that of the bulk material. By introducing appropriately dimensioned air gaps between laminae formed from a bulk dielectric material, the effective permittivity ε′ of a laminar structure can be reduced relative to the bulk dielectric material. As described in detail below, by producing slanted laminae that slanted relative to first and second surfaces and that are separated by air gaps, and by overlapping the slanted laminae such that the volume of the laminae and the volume of the air is approximately the same at any given cross-section taken with respect to a line drawn perpendicular to the first and second surfaces, an approximately uniform effective permittivity ε′ may be produced. In other implementations, by varying one or more of the slant angles, the thicknesses, or the spacing between the laminae, the effective permittivity ε′ can be adjusted.

In the following discussion, it should be understood that calculating the permittivity of the dielectric material or of the dielectric material formed with air gaps and slanted laminae is at least partially a function of the frequency f (or wavelength λ, e.g., fλ=c, where c represents the speed of light) of the radio frequency signals and at least partially a function of the angle at which the radio frequency signals pass through the dielectric material structure (laminar structure). In the following discussion, the laminae may extend between a first side and a second side, and the effective permittivity resulting from the configurations of laminae may be understood with respect to radio frequency signals that pass through the laminar structure perpendicular to the first side and the second side. With respect to a driving patch antenna and a parasitic patch antenna, the effective permittivity resulting from the configurations of laminae may be understood with respect to radio frequency signals that pass from one antenna to the other through the laminar structure. It should be understood that the effective permittivity at a first frequency may be different from the effective permittivity at a second frequency for the same laminar structure.

Additive manufacturing technologies, such as 3D printing, often have predefined patterns that could be used to provide the low in-fill dielectric structure. However, typical in-fill 3D printing patterns may result in non-uniform distribution of the bulk material and the air content at any given cross-section, which may skew the radiation pattern when used in conjunction with an antenna. In one or more embodiments, a fine air-cell size may be desirable, which may be one order of magnitude smaller than the patch antenna, but such sizes may be beyond the capability of state-of-the-art 3D printing manufacturing capabilities. However, it is expected that 3D printing processes will continue to improve, and that the precision of the 3D printing processes will soon enable smaller sizes. Currently, printing high resolution structures is slow and expensive. In some applications, the fine feature size may not be mechanically robust enough during assembly and field application. However, the structure and design methodology can be used with other manufacturing processes, when application needs are beyond additive manufacturing capabilities. For example, the minimum opening size may be 0.10 mm for high resolution resin-based printing when an antenna size is 0.55 mm. The antenna size could be smaller than 0.5 mm when operating at greater than one hundred gigahertz (100 GHz).

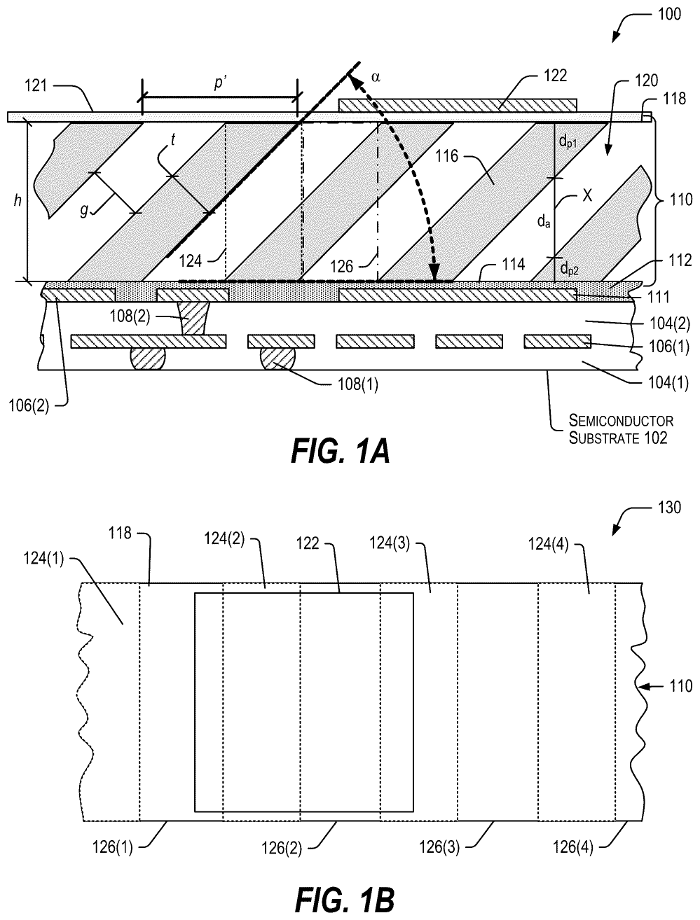

Embodiments of antenna circuits and laminar structures that can be used in connection with such antennas are described below that provide a low in-fill density with a uniform dielectric density at any cross-section of the antenna and the underlying low in-fill density dielectric. In one or more embodiments, the laminar structure may include slanted, overlapping laminae are produced that have a selected slant angle α, a selected pitch distance p, a selected thickness t, and a selected air gap size g. In one or more embodiments, the slanted, overlapping laminae may have spatially varying thicknesses and varying slant angles that may be selected to provide a selected antenna radiation pattern, coverage, and gain. An example of an antenna device including a low in-fill dielectric structure is described below with respect to FIG. 1A.

FIG. 1A depicts cross-sectional view of a portion of a substrate-based antenna device 100 including a low in-fill dielectric structure 110 formed from slanted laminae 116, in accordance with one or more embodiments. The substrate-based antenna device 100 may include a semiconductor substrate 102 including multiple layers. The semiconductor substrate 102 may include one or more metal layers 106 separated by one or more dielectric layers 104 and may include metal interconnects 108, which may couple metal layers 106 through one or more of the dielectric layers 104. In the illustrated example, the interconnect 108 may electrically couple the metal layer 106(1) to a contact pad or terminal on an underlying substrate (not shown), such as a printed circuit board or a semiconductor die. The interconnect 108(2) may electrically couple the metal layer 106(1) to the metal layer 106(2), which may include a contact pad to electrically couple to other circuitry. In one or more embodiments, the metal layer 106(2) may include a driving patch antenna 111, which may be part of the antenna. The metal layer 106(1) may include a ground plane that may be coupled to the ground of the semiconductor substrate 102, which may be coupled to a reference potential or ground connection of a larger circuit.

In the illustrated example, the driving patch antenna 111 may be covered by a thin film (solder mask or other material layer) 112 to seal the antenna 111 from the environment. In one or more embodiments, the thin film 112 has an opening on the driving patch antenna 111 to minimize the loss with thin film material 112. In one or more embodiments, a metal finish might be included for the driving patch antenna 111 to protect it from the environment. Depending on the type of metal, the metal finish could include gold, or another metal selected to provide protection for driving patch antenna 111. In one or more embodiments, the substrate-based antenna device 100 may include a low in-fill dielectric structure 110, which may include a first surface 114 coupled to the thin film 112, a second surface 118 provided by a flat cap layer 121, and a plurality of slanted laminae 116 separated by air gaps 120. Each of the laminae that extend between the first surface 114 and the second surface 118. The antenna device 100 may include a parasitic patch antenna 122 disposed on the flat cap layer 121.

In one or more embodiments, the driving patch antenna 111 may generate radio frequency signals that may pass through the low in-fill dielectric structure 110 (including the laminae 116 and the air gaps 120) to the parasitic patch antenna 122, causing the parasitic patch antenna 122 to resonate and to produce radio frequency signals for transmission. Radiation produced by the driving patch antenna 111 toward the semiconductor substrate 102 is reduced by the ground plane of the metal layers 106(1).

In general, the substrate-based antenna device 100 includes an antenna formed by the driving patch antenna 111 and the parasitic patch antenna 122. The driving patch antenna 111 and the parasitic patch antenna 122 have very thin structures (relative to other materials) that have low volume and weight and that can provide a large aperture with a corresponding high gain. The dielectric layer may be selected to fit different applications. Air dielectric has a relatively low loss, making patch antenna arrays useful for wireless communication systems where low weight and high gain are desirable. When used with a material having a relatively high dielectric constant, such as ceramics or other material, a resonant cavity may be formed that is an integer multiple of the wavelength within the cavity. High dielectric means the wavelength is reduced compared to the free-space wavelength, meaning the cavity size can be smaller than would be otherwise required. However, such high-dielectric material may increase signal loss.

In the illustrated embodiment, the slanted laminae 116 may have a pitch size p′ with an overlap region 124 in which adjacent slanted laminae 116 overlap, as depicted by the dotted rectangle 124. There may also be non-overlapping regions 126 in which a slanted laminae 116 is not overlapping with adjacent slanted laminae 116. Each slanted laminae 116 may have a slant angle α. The structure thickness (or height) h may represent the distance between the first surface 114 and the second surface 118. Each slanted laminae 116 may have a thickness t and may be separated from adjacent slanted laminae 116 by air gaps g.

In one or more embodiments, the slant angle α, the pitch size p′, and the thickness t may be selected to be substantially uniform to ensure that, along any vertical line that extends from the first surface 114 to the second surface 118, the effective permittivity at the location of the line is the approximately same as any other location along the structure. In other words, the amount of air gap and the amount of bulk printed material at any vertical cross section is approximately the same (within manufacturing tolerances) at any point along the length of the low in-fill dielectric structure 110, providing an approximately uniform effective permittivity at any location for structures that are sufficiently small relative to the wavelength. In other words, both the total printed dielectric thickness dₚ (dₚ₁+dₚ₂) and the total air thickness dₐ are uniform at any location X with a given laminae slant angle α and laminae layer thickness t. Hence, the effective permittivity ε′ is constant at any location X, providing a uniform dielectric structure and uniform effective permittivity ε′ for radio frequency (RF) functional elements, such as the driving patch antenna 111 and the parasitic patch antenna 120.

In one or more embodiments, the pitch size p′ may be determined as a function of the total structure thickness h and the slant angle α as follows:

$${p}^{′} = \frac{h}{tan α} \qquad ( 1 )$$

In this example, the first surface 114 and the second surface 118 are parallel to one another. At any location at which a line is drawn that is perpendicular to the first and second surfaces 114 and 118 and that extends between the first surface 114 and the second surface 118, one or more of the slanted laminae 116 may be intersected and the bulk printed material thickness dp at that location is determined as follows:

$${d}_{p} = \frac{t}{cos α} \qquad ( 2 )$$

The total thickness of the air dₐ may be determined by subtracting the bulk printed material thickness dₚ from the total structure thickness h as follows:

$${d}_{a} = h - {d}_{p} \qquad ( 3 )$$

The effective permittivity ε′ may be determined as follows:

$${ε}^{′} = \frac{{ε}_{p} {ε}_{a} h}{{ε}_{a} {d}_{p} + {ε}_{p} {d}_{a}} \qquad ( 4 )$$

Conventional low in-fill dielectrics may experience warpage, may be difficult to manufacture, may be relatively expensive (e.g., glass cavity), or may have a spatially variable dielectric (e.g., printed in-fill dielectric patterns). In the example embodiment of FIG. 1A, the low in-fill dielectric structure 110 between the driving patch antenna 111 and the parasitic patch antenna 122 may be formed by an additive layer printing process in which the structures may be printed, layer by layer, to form slanted laminae 116 having a selected thickness t, a selected slant angle α, a selected air gap size g, and a laminar pitch size p to provide a selected effective permittivity ε′. where ε′ is the effective permittivity, εₚ is the permittivity of the printed bulk material, εₐ is the permittivity of the air gap, dₚ is the depth of the printed bulk material, dₐ is the depth of the air gap, and h represents the structure thickness (or height). Depending on the slant angle α and the pitch size p′, there may be overlapping regions 124 and non-overlapping regions 126 in which there is no overlap between a first laminar 116 and an adjacent laminae 116.

FIG. 1B depicts a top view 130 of a portion of the substrate-based antenna device 100 of FIG. 1A including dotted lines indicating overlap regions 124 and non-overlap regions 126 of the slanted laminae 116, in accordance with one or more embodiments. In this example, the parasitic antenna 122 may be on the second surface 118, and the underlying overlap regions 124 are indicated by rectangles having dotted lines. The non-overlap regions 126 are between the overlap regions. While in this example, the overlap regions 124 and the non-overlap regions 126 are approximately the same size, in other embodiments, the overlap regions 124 may be larger than the non-overlap regions 126 or less than the non-overlap regions 126. The size of the overlap regions 124 may be determined by the pitch size p′ and the thickness t of the laminae 116 relative to the total structure thickness h.

In the following discussion, various examples of the low in-fill dielectric structure 110 are described in which various parameters associated with the structure are varied. As described below, the effective permittivity ε′ may be varied by adjusting one or more of the laminar thickness t, the slant angle α, the pitch size p′, the air gap size g.

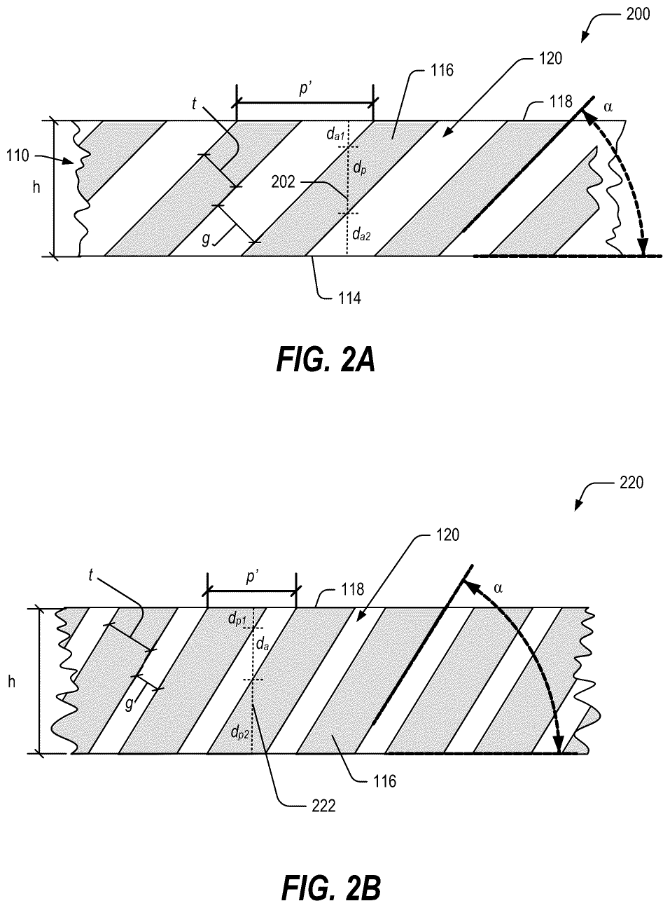

FIG. 2A depicts a cross-sectional view of a portion 200 of the low in-fill dielectric structure 110 including slanted laminae 116 separated by air gaps 120, in accordance with one or more embodiments. The low in-fill dielectric structure 110 has a thickness or height h. The portion 200 may include a first side 114, a second side 118, and laminae 116 that extend between the first side 114 and the second side 118 at a selected slant angle α. Each lamina 116 has a thickness t and a slant angle α. The laminae 116 may be separated from one another by a pitch size p′ forming an air gap width g between each lamina 116.

In the illustrated example, at any location, the low in-fill dielectric structure 110 has a regular or ordered distribution of bulk printed material (laminae 116) and air (air gap 120) to provide a uniform effective permittivity ε′. At the slice represented by dashed line 202, the effective permittivity ε′ at that location corresponds to the permittivity of the bulk printed material εₚ and the permittivity of the air gap εₐ, which is a function of the depth of the printed bulk material at that slice and the depth of the air gap at the same slice. In this example, the depth of the air gap includes the sum of dₐ₁ and dₐ₂ and the depth of the bulk printed material includes dₚ.

In one or more embodiments, with a given thickness t of the laminae 116, the slant angle α of the laminae 116 may be changed. To maintain the uniform effective permittivity ε′ across the laminae with a change to the slant angle α, the pitch size p′ and the air gap g are changed, and the resulting low in-fill dielectric structure 110 may present a different effective permittivity ε′. In the following example, the slant angle α is increased, causing the air gap g and the pitch size p′ to decrease as shown in FIG. 2B.

FIG. 2B depicts a cross-sectional view of a portion 220 of the low in-fill dielectric structure 110 including slanted laminae 116 separated by air gaps 120, in accordance with one or more embodiments. In this example, the slant angle α is larger than the slant angle in FIG. 2A, causing the pitch size p′ and the air gap size g to be smaller than in FIG. 2A. As shown, the location of the slice as indicated by the dashed line 222 includes overlapping portions of the laminae 116, such that the effective permittivity ε′ is related to the depth of the air gap dₐ and the sum of the depths of the bulk printed material dₚ₁ and dₚ₂.

In one or more embodiments, the relative permittivity of the bulk material εₚ may be 3.50, the laminar thickness t may be 150 μm, and the structure thickness h may be 500 μm. Keeping the laminar thickness t and the structure thickness h constant, the effective permittivity ε′ may be varied by adjusting the slant angle α as shown in the following table 1.

TABLE 1
Effective Permittivity Change with Slant Angle Changes

| α | 30 | 35 | 40 | 45 | 50 | 55 | 60 | 65 | 70 | 73 |
|---|---|---|---|---|---|---|---|---|---|---|
| ε′ | 1.33 | 1.35 | 1.39 | 1.43 | 1.50 | 1.60 | 1.75 | 2.03 | 2.68 | 3.50 |

In this example, as the laminar slant angle α increases, the air gap g and the laminar pitch size p decrease, increasing the effective permittivity ε′. Depending on the slant angle α and the pitch size p′, there may be overlapping regions 124 and non-overlapping regions 126 in which there is no overlap between a first laminar 116 and an adjacent lamina 116 (as shown in FIGS. 1A and 1B).

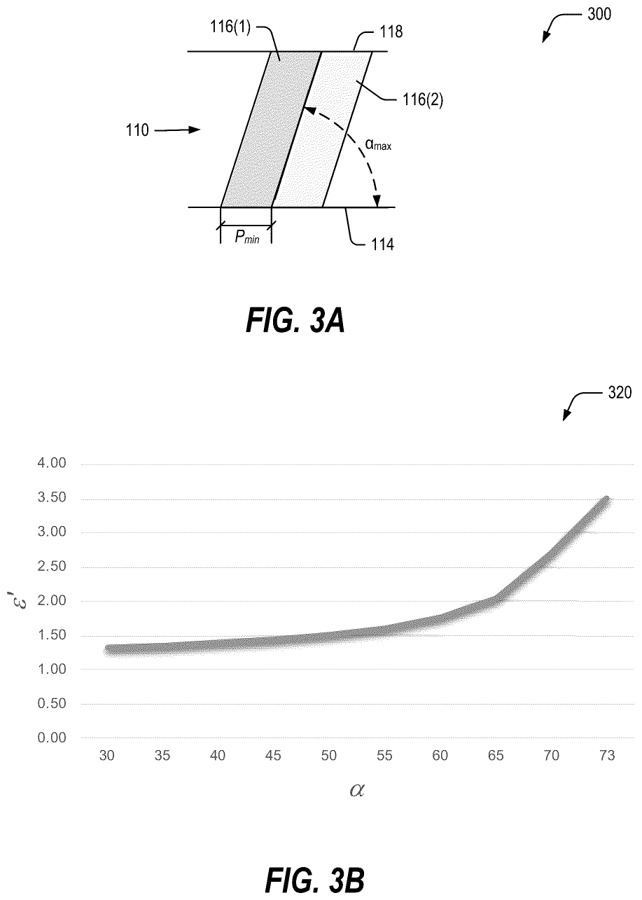

When laminae slant angle α increases, the air gap g and laminar pitch size p′ decrease. When air gap g decreases to zero, the dielectric structure become solid with 100% printed dielectric material. The effective permittivity ε′ equals to the permittivity of bulk printing material (εₚ). An example of such a configuration is described below with respect to FIG. 3A.

FIG. 3A depicts a cross-sectional view of a portion 300 of the low in-fill dielectric structure 110 including slanted laminae 116 with a maximum laminar slant angle α and minimum pitch size p′, in accordance with one or more embodiments. In this example, the slant angle α is increased to a maximum angle, which a function of the thickness as follows:

$${α}_{max} = {cos}^{- 1} \frac{t}{h} . \qquad ( 5 )$$

As previously discussed, when the slant angle α increases, the air gap g and the pitch size p′ decrease. When the slant angle α reaches the maximum (αₘₐₓ), the pitch size p′ and the air gap g are at the minimum as follows:

$${p}_{min} = \frac{t}{sin {α}_{max}} \qquad ( 6 )$$

When air gap g decreases to zero, the structure become solid with 100% printed dielectric material, and the effective permittivity ε′ equals the permittivity of bulk printing material εₚ.

Thus, in an example where the permittivity of the bulk printing material εₚ is 3.5, the thickness t is 150 μm, and the height h is 500 μm, the maximum slant angle αₘₐₓ is 73.54°, the minimum pitch size is 157 μm, and the effective permittivity ε′ is 3.5, which is the same as the permittivity of the bulk printing material. In general, the effective permittivity ε′ may vary based on the slant angle as described below with respect to FIG. 3B.

FIG. 3B depicts a graph 320 of effective permittivity ε′ versus laminar slant angle α, in accordance with one or more embodiments. The graph 320 shows that the effective permittivity ε′ is approximately 1.33 at a slant angle α of thirty degrees and increases at a slowly increasing (almost linear) rate until the slant angle α reaches approximately fifty-five degrees. At fifty-five degrees, the effective permittivity ε′ increases exponentially until it reaches the permittivity of the bulk printed material εₚ. The effective permittivity ε′ can be determined according to Equation 4 above.

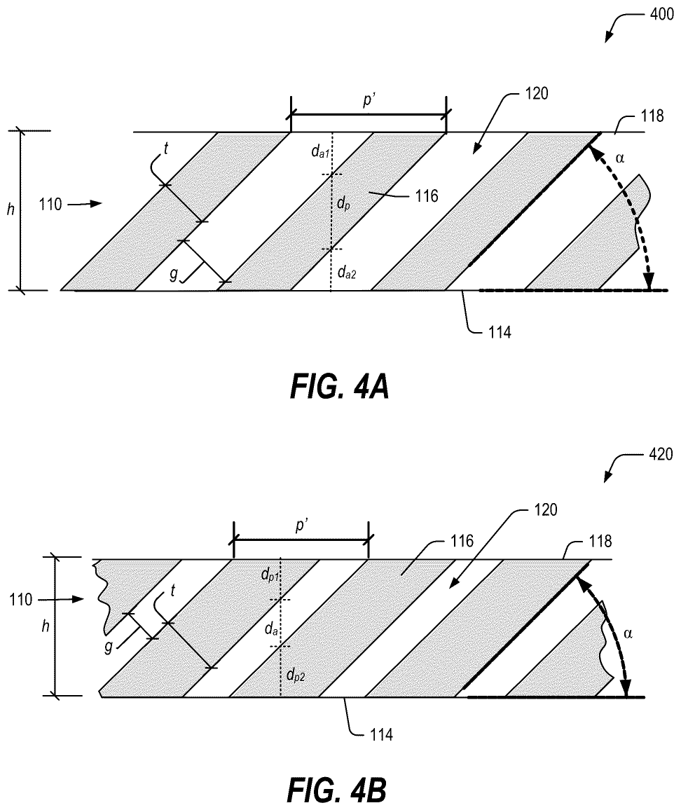

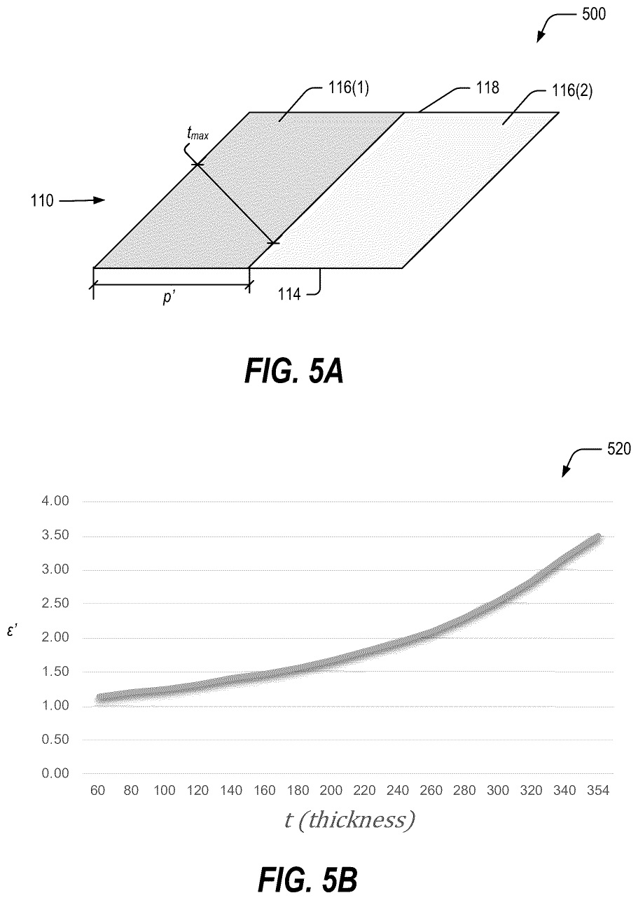

In the examples of FIGS. 2A-3B, the laminae 116 had the same thickness t and the slant angle α was changed to alter the effective permittivity ε′. In the following discussion of FIGS. 4A-5B, the slant angle α is constant, and the thickness t of the laminae 116 is varied to alter the effective permittivity ε′.

FIG. 4A depicts a cross-sectional view of a portion 400 of the low in-fill dielectric structure 110 including slanted laminae 116 having a selected laminar slant angle α and a selected laminar thickness t, in accordance with one or more embodiments. In this example, the permittivity of the bulk printing material εₚ is 3.50, and the structure thickness or height h is 500 μm. The slant angle α is approximately forty-five degrees (45°). With the slant angle α and the height h held constant, the pitch size p′ is determined according to the following equation:

$${p}^{′} = \frac{h}{tan α} . \qquad ( 7 )$$

FIG. 4B depicts a cross-sectional view of a portion 420 of the low in-fill dielectric structure 110 including slanted laminae 116 with a selected laminar thickness t and a selected slant angle α, in accordance with one or more embodiments. In this example, the thickness t of the laminae 116 is greater than in FIG. 4A.

In one or more embodiments, with a given slant angle α, when adjusting the thickness t of the laminae 116, the air gap g will change, providing a different effective permittivity ε′. In an example, the permittivity of the bulk printed material εₚ may be 3.50, the slant angle α may be forty-five degrees (45°), and the structure thickness or height h is 500 μm. The thickness t of the laminae 116 may be changed, altering the air gap g and resulting in changes to the effective permittivity ε′. It should be understood that there is a maximum thickness tₘₐₓ at the slant angle α, as described below with respect to FIG. 5A.

FIG. 5A depicts a cross-sectional view of a portion 500 of the low in-fill dielectric structure 110 including slanted laminae 116 with a maximum thickness tₘₐₓ, in accordance with one or more embodiments. When the slant angle α is constant at forty-five degrees (45°), increasing the thickness t of the laminae 116 reduces the air gap g and alters the effective permittivity ε′ as shown in Table 2 below.

TABLE 2
Effective Permittivity Change with Laminae Thickness Changes

| t | 60 | 100 | 140 | 160 | 180 | 200 | 220 | 240 | 260 | 280 | 300 | 320 | 340 | 354 |
|---|---|---|---|---|---|---|---|---|---|---|---|---|---|---|
| ε′ | 1.14 | 1.25 | 1.39 | 1.48 | 1.57 | 1.68 | 1.8 | 1.94 | 2.11 | 2.30 | 2.54 | 2.83 | 3.19 | 3.50 |

In this example, when the thickness is approximately 354 μm, the air gap g is zero, and the effective permittivity ε′ is equal to the permittivity of the bulk printed material. Since the relative dielectric permittivity of the laminae 116 is greater than the air of the air gaps 120, as the thickness t increases, the effective dielectric ε′ increases until a maximum thickness tₘₐₓ is reached at 354 μm.

FIG. 5B depicts a graph 520 of effective permittivity ε′ versus laminar thickness t, in accordance with one or more embodiments. As shown, the effective permittivity ε′ increases as a function of the thickness t of the laminae 116. The graph 520 is a slowly increasing exponential until the laminae thickness t reaches the maximum and the dielectric structure becomes one hundred percent (100%) printed dielectric material.

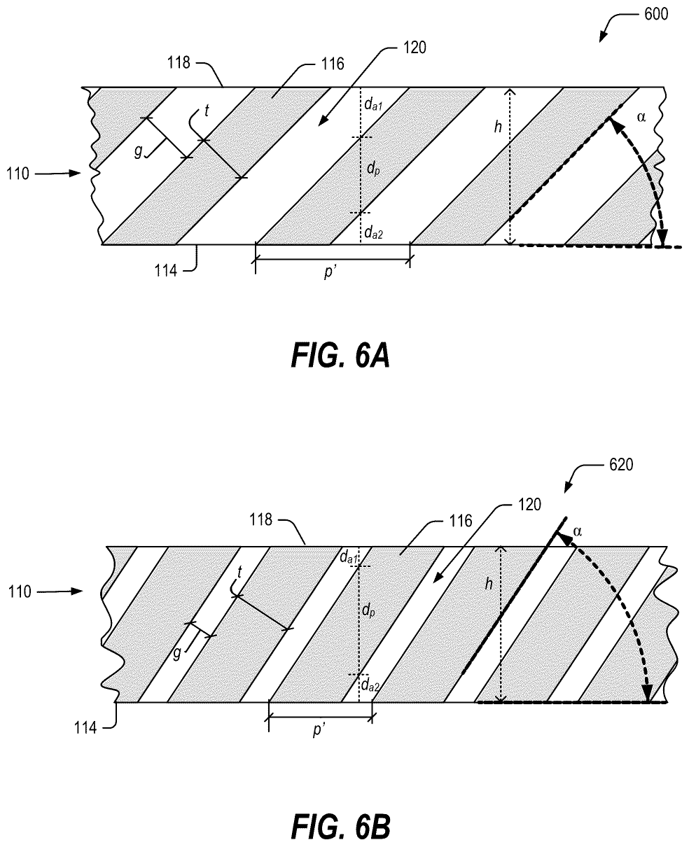

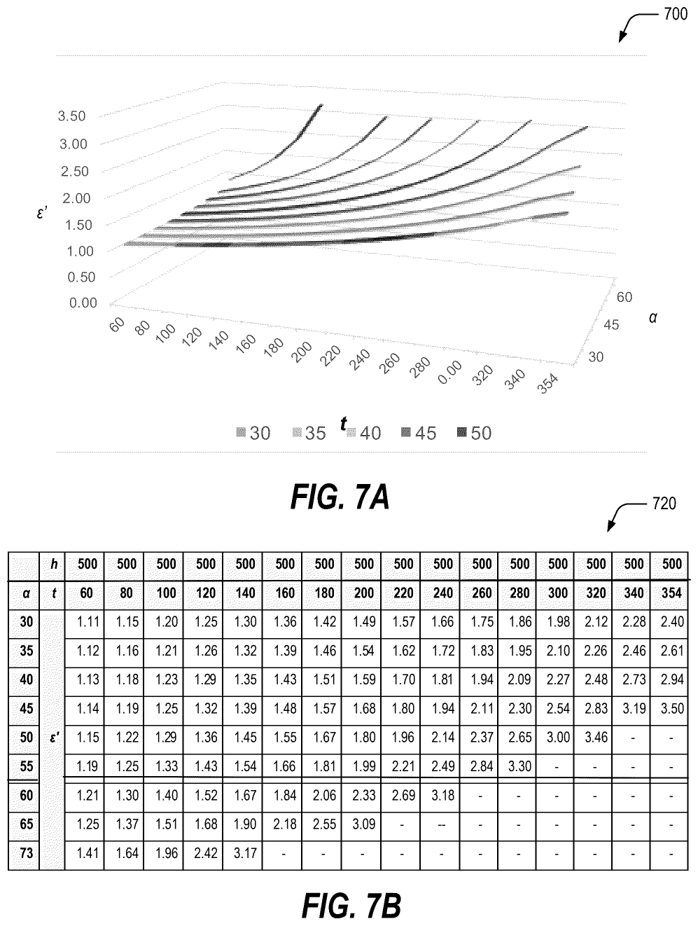

The dielectric material composition, the thickness t, and the slant angle α may determine the effective permittivity ε′. For design, the slant angle α and the thickness t may be adjusted together to provide a selected effective permittivity ε′ and printability. In the following discussion of FIGS. 6A-7B, the thickness t and the slant angle α may be adjusted together.

FIG. 6A depicts a cross-sectional view of a portion 600 of the low in-fill dielectric structure 110 including slanted laminae 116 having a first selected laminar slant angle α and a first selected laminar thickness t, in accordance with one or more embodiments. The portion 600 includes laminae 116 that are separated from one another by a first air gap g and that have a first pitch size p′. At any given location, the effective permittivity ε′ is uniform.

FIG. 6B depicts a cross-sectional view of a portion 620 of the low in-fill dielectric structure 110 including slanted laminae 116 with a second selected slant angle α and a second selected laminar thickness t, in accordance with one or more embodiments. The second slant angle α is larger than the first slant angle α of the structure in FIG. 6A. The pitch size p′ and the air gap g are smaller than in FIG. 6A.

In general, changing the slant angle α and the thickness t of the laminae 116 together may enable a designer to select an effective permittivity ε′ for a particular embodiment. The effective permittivity ε′ may be determined as follows:

$${ε}^{′} = \frac{{ε}_{p} {ε}_{a} h}{{ε}_{a} \frac{t}{cos α} + {ε}_{p} ( h - \frac{t}{cos α} )} \qquad ( 8 )$$

where εₚ represents the permittivity of the bulk printed material, εₐ represents the permittivity of air, h is the structural thickness or height, t is the thickness of the laminae 116, and α is the slant angle. Once the bulk printing material is selected, the permittivity of the bulk printing material εₚ can be determined and the thickness t and the slant angle α can be selected to provide the selected effective permittivity ε′.

FIG. 7A depicts a graph 700 of effective permittivity ε′ versus laminar thickness t and slant angle α, in accordance with one or more embodiments. The graph includes multiple lines indicative of the effective permittivity ε′ at selected thicknesses t (60-354 μm) and selected slant angles α (30°-73°). As shown, as one or more of the slant angle α or the thickness t increase, the effective permittivity ε′ increases.

FIG. 7B depicts a table 720 showing the effective permittivity ε′ change with slant angle α and laminar thickness t, in accordance with one or more embodiments. In this example, the permittivity of the bulk printed material is 3.50, and the structure thickness or height h is 500 μm.

As shown, variations in either or both of the slant angle α and the laminar thickness t produces a different effective permittivity ε′. The bottom right portion of the table 720 shows a “-” because the thickness t and the slant angle α cannot exist in the particular combinations.

It should be appreciated that, depending on the manufacturing capability and the material properties, certain sizes and angles may not be printable. Accordingly, there may be a “working zone” that can be determined as a design rule. In one or more embodiments, the manufacturing processes may not work with slant angles α that are smaller than forty degrees (40°) or with an air gap g that is less than 100 μm, because those angles and those sizes may lead to printing or manufacturing issues.

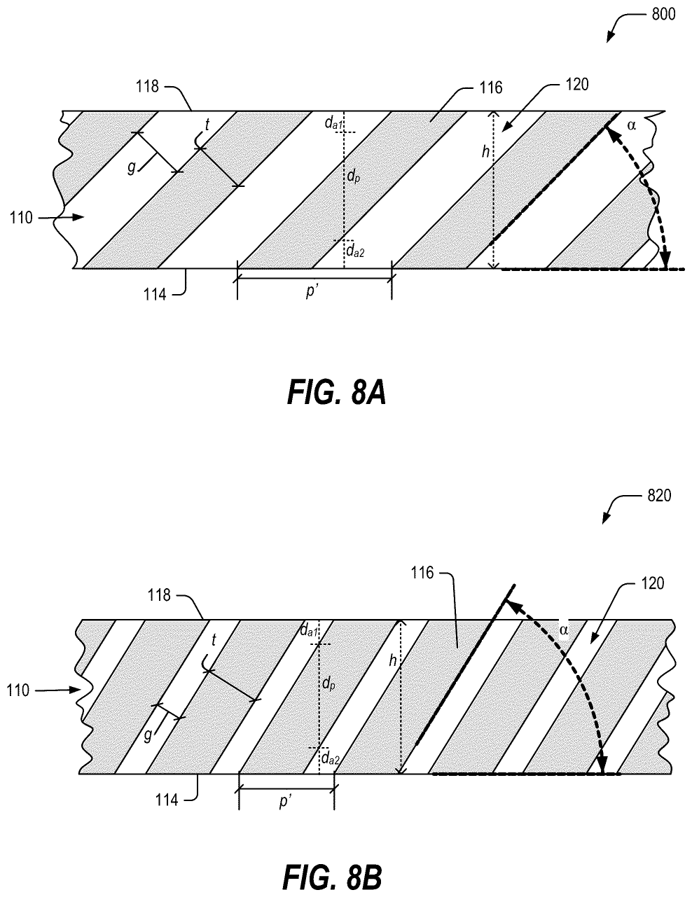

FIG. 8A depicts a cross-sectional view of a portion 800 of the low in-fill dielectric structure 110 including slanted laminae 116 having a selected laminar slant angle α, a selected laminar thickness t, a selected air gap size g, and a selected laminar pitch size p′ to provide a selected effective permittivity ε′, in accordance with one or more embodiments.

FIG. 8B depicts a cross-sectional view of a portion 820 of the low in-fill dielectric structure 110 including slanted laminae 116 with a selected laminar slant angle α, a selected laminar thickness t, a selected air gap size g, and a selected laminar pitch size p′ to provide a selected effective permittivity ε′ that is different from that in FIG. 8A, in accordance with one or more embodiments.

Comparing the portions 800 and 820 in FIGS. 8A and 8B, it should be noted that the slant angle α in FIG. 8B is greater than in FIG. 8A, and the air gap g and the pitch size p′ are smaller than in FIG. 8A. The differences produce a first effective permittivity ε′₁ in FIG. 8A and a second effective permittivity ε′₂ in FIG. 8B.

As mentioned above, there may be manufacturing limits with respect to the slant angle α and the air gap g. In one possible example, printing machinery may be limited to slant angles α that are greater than or equal to forty degrees and the air gap g may have a size that is greater than or equal to 100 μm. The manufacturing limitations may introduce limitations that may be viewed as design rules, such that the selection of the thickness t and slant angle α may be restricted to a working area or working zone that is within manufacturing capabilities. As used herein, the term “working zone” refers to a range of selected physical parameters of the low in-fill dielectric structure 110 that can be produced reliably using additive manufacturing processes. Physical parameters (such as a slant angle α that is less than a threshold angle or a size of an air gap g that is less than a threshold air gap size) may present printing issues with current additive manufacturing processes.

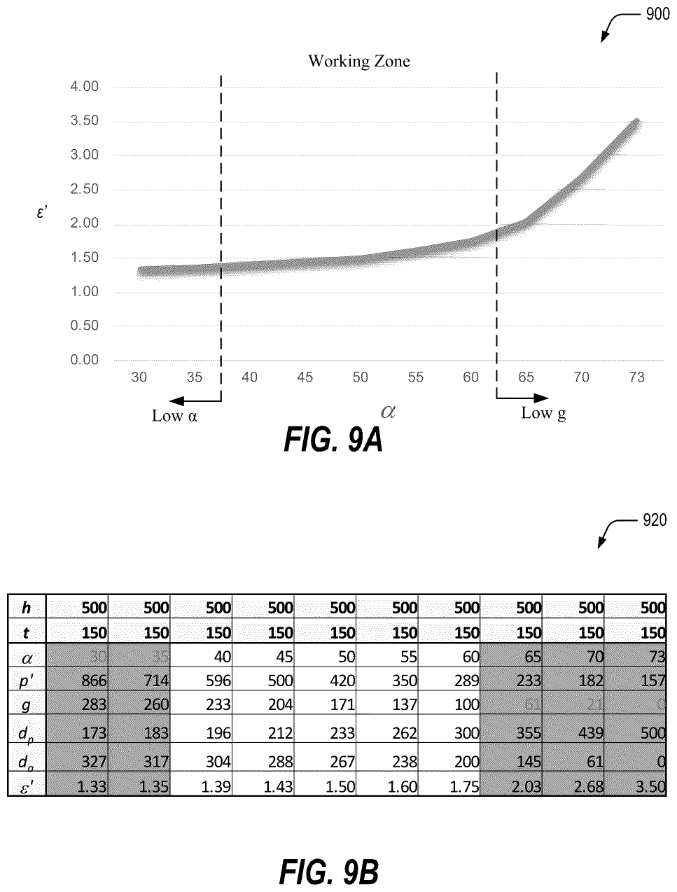

FIG. 9A depicts a graph 900 of effective permittivity ε′ versus slant angle α in a working zone, in accordance with one or more embodiments. At slant angles α that are below forty degrees (<40°), the design is outside of the working zone, such that the slant angle α may be difficult to produce using current additive manufacturing processes. Similarly, at slant angles that are greater than about sixty-two degrees (62°), the air gap g may be too small to produce reliably using current additive manufacturing processes. This leaves a working zone that is between the low slant angle α and the low air gap g.

FIG. 9B depicts a table 920 showing the effective permittivity ε′ change with slant angle α and laminar thickness t in a working zone, in accordance with one or more embodiments. The slant angles α that are too small or too large for the current additive manufacturing processes are shaded darker than the lighter working zone. As shown at slant angles α starting at sixty-five degrees, the air gap g is only 61 μm and the air gap g becomes smaller at higher slant angles α. As mentioned, current additive manufacturing processes may struggle to produce the dielectric structure reliably with such small air gaps g.

It should be appreciated that the additive manufacturing processes are evolving and may enable smaller air gaps g and larger slant angles α in the near future. Accordingly, the table 920 and the graph 900 may reflect current limitations in the manufacturing technology, which may be supplanted as the additive manufacturing processes continue to improve, enabling air gaps g that are smaller than 61 μm.

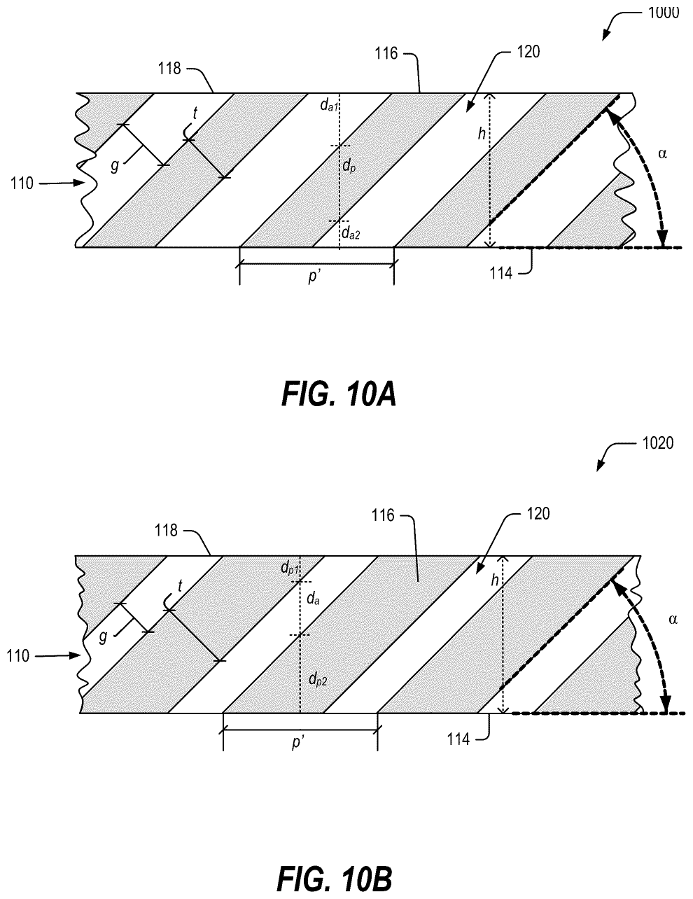

It should be appreciated that, since the size of the air gap g and the size of the slant angle α may be limited by the additive manufacturing processes, the thickness t of the laminae 116 may also be limited by the additive manufacturing processes. As the thickness t increases, the air gap g becomes smaller, which may lead to problems with the additive manufacturing processes, as will be discussed in more detail below with respect to FIGS. 10A and 10B.

FIG. 10A depicts a cross-sectional view of a portion 1000 of the low in-fill dielectric structure 110 including slanted laminae 116 having a selected thickness t to provide a selected effective permittivity ε′, in accordance with one or more embodiments. In this example, the slanted laminae 116 have the selected thickness t and a selected slant α, which determine an air gap g.

FIG. 10B depicts a cross-sectional view of a portion 1020 of the low in-fill dielectric structure 110 including slanted laminae 116 with a selected laminar thickness t to provide a selected effective permittivity ε′, in accordance with one or more embodiments. In this example, the slanted laminae 116 have the selected thickness t that is greater than in FIG. 10A, which determine an air gap g that is smaller than in FIG. 10A.

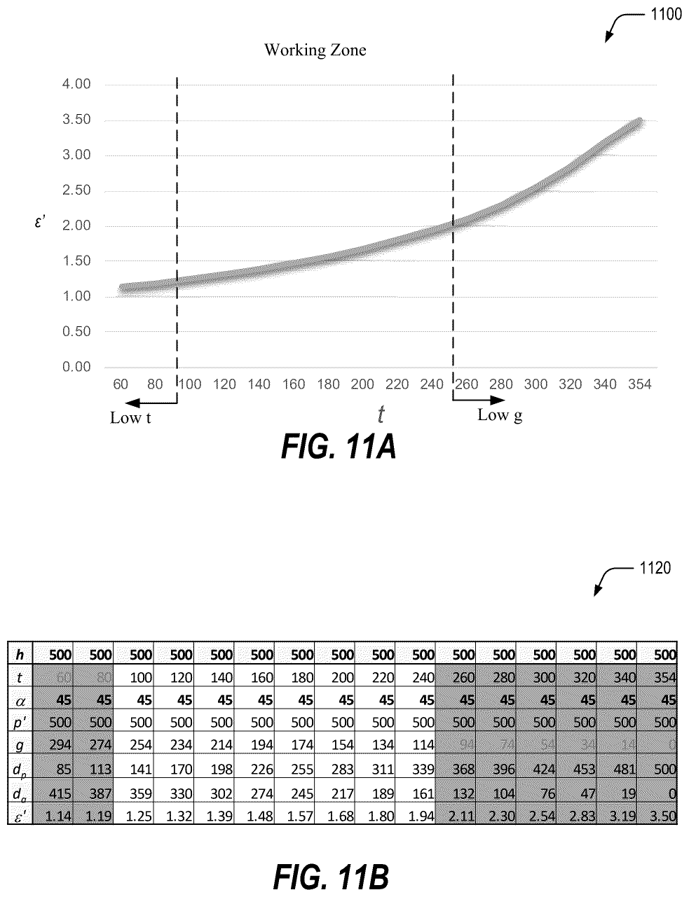

As discussed above, with a given slant angle α, when the thickness t changes, the air gap g also changes, resulting in a different effective permittivity ε′. An example of a graph of the effective permittivity ε′ versus the thickness t of the slanted laminar structures 116 is described below with respect to FIGS. 11A and 11B.

FIG. 11A depicts a graph 1100 of effective permittivity ε′ versus laminar thickness t in a working zone, in accordance with one or more embodiments. As shown in the graph 1100, the working zone between the low slant thickness t and the low air gap g is shaped similar to the graph 900 in FIG. 9A. In this example, at thicknesses t that are greater than about 95 μm or smaller than about 255 μm, the graph 1100 depicts a working zone within which the additive manufacturing technologies can produce the low in-fill dielectric structure 110. The effective permittivity ε′ increases across the working zone.

FIG. 11B depicts a table 1120 showing the effective permittivity ε′ change with varying laminar thickness t in the working zone, in accordance with one or more embodiments. The table 1120 includes shaded areas for thicknesses t that are outside of the working zone. In this table, the slant angle α is held constant at 45 degrees.

In general, the areas in the graphs 900 and 1100 and in the tables 920 and 1120 depict regions in a working zone within which the additive manufacturing processes can produce the low in-fill dielectric structure 110 reliably. The working zone ensures good printability, avoiding printing issues that might adversely impact the uniformity of the selected effective permittivity ε′. As previously mentioned, as the additive manufacturing processes improve, the working zone may shift or increase because the smaller slant angles α or the smaller or larger thicknesses t or the smaller air gaps g can be produced reliably.

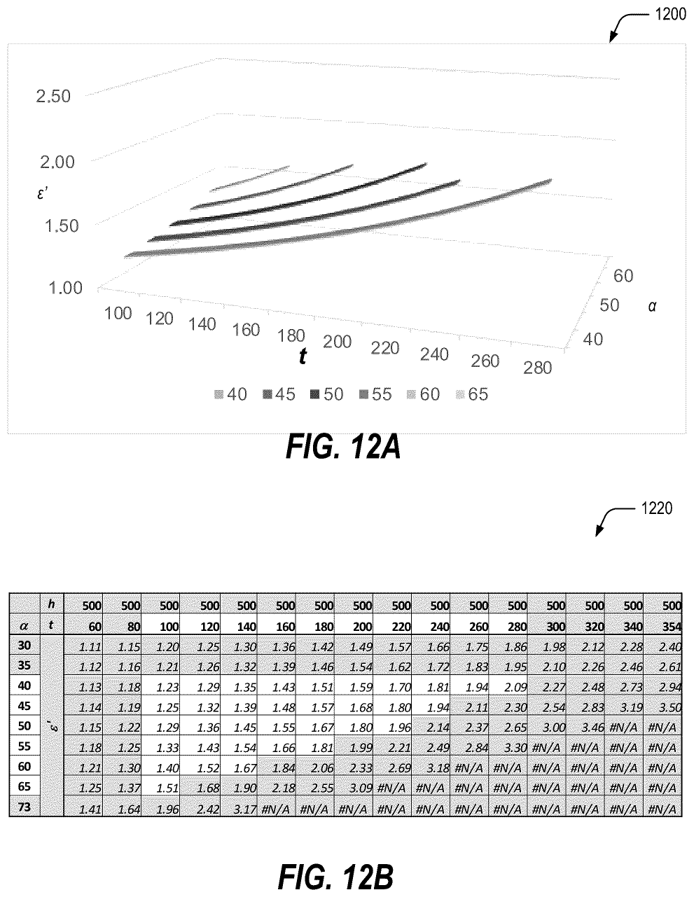

When both the slant angle α and the thickness t are varied, the working zone can be determined with constraints of minimum slant angle α, minimum thickness t, and air gap g based on the material properties and the capabilities of the additive manufacturing process. For example, in one or more embodiments, regions with a slant angle α that is less than forty degrees or a thickness t that is less than 100 μm, or an air gap g that is less than 100 μm may be excluded. An example of the effective permittivity ε′ based on the varied thickness t and varied slant angle α are described below with respect to FIGS. 12A and 12B.

FIG. 12A depicts a graph 1200 of a graph of effective permittivity ε′ versus laminar thickness t and slant angle α in a working zone, in accordance with one or more embodiments. In the illustrated example, the graph 1200 shows that as the slant angle α increases, the range of thicknesses t decreases at which the low in-fill dielectric structures 110 remains within the working zone. Similarly, the graph 1200 shows that as the thickness t increases, the range of slant angles α becomes smaller the low in-fill dielectric structures 110 remains within the working zone.

FIG. 12B depicts a table 1220 of the effective permittivity 8′ versus laminar thickness t and slant angle α in the working zone, in accordance with one or more embodiments. As shown in the table 1220, regions with the slant angle α that are less than forty degrees or the thicknesses t that are smaller than 100 μm or the air gaps g that are less than 100 μm are outside of the working zone and may be therefore excluded. In the table 1220, the region in white is the working zone with good printability. The low in-fill dielectric structures 110 can be manufactured using additive manufacturing processes that have an effect permittivity ε′ between 1.23 to 2.09 with a bulk printed material permittivity ε′ of 3.5. The low in-fill dielectric structures 110 may present a uniform effective permittivity ε′ across the structure, which reducing the effective permittivity ε′ relative to the permittivity e of the bulk printed material, which can significantly improve the signal gain.

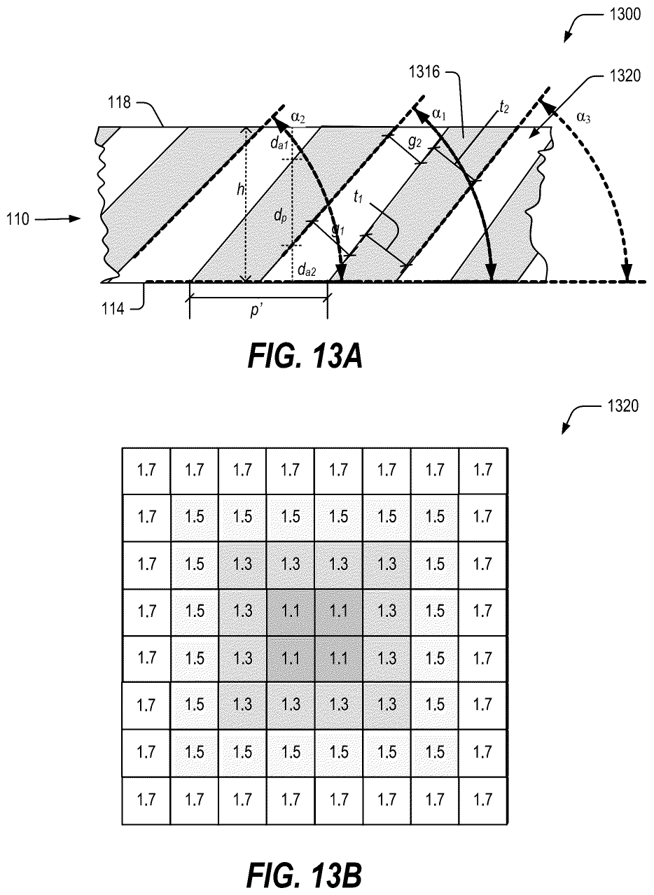

In the above-discussion, the slant angles α and thicknesses t of the laminae 116 were constant within a selected low in-fill dielectric structure 110. It should be appreciated that the changes in the effective permittivity ε′ in response to changes in the slant angle α or the thickness t may be varied to produce a selected effect. For example, as discussed below with respect to FIGS. 13A and 13B, one or more of the thickness t or the slant angle α of the low-in-fill dielectric structure 110 may be changed gradually within a single antenna element to provide a gradient index of dielectric properties to enhance the antenna radiation pattern, coverage, and gain. An example of a low in-fill dielectric structure 110 that includes laminae 116 with spatially varying thicknesses t and a spatially varying air gap g is described below with respect to FIG. 13A.

FIG. 13A depicts a cross-sectional view of a portion 1300 of the low in-fill dielectric structure 110 including slanted laminae 1316 with one or more selected gradient indices across which one or more of the laminar thickness t or the laminar slant angle α gradually change, in accordance with one or more embodiments. In one or more embodiments, the pitch size p′ may be varied across the low in-fill dielectric structure 110. In one or more embodiments, the slant angle α₁ may be varied from one laminae 116 to the next across the low in-fill dielectric structure 110. In one or more embodiments, the thickness t of the laminae 116 may be varied from one laminar structure to the next, along a height of one or more of the laminae 116 of a low in-fill dielectric structure 110, or any combination thereof.

In this example, the air gap g₁ near the first surface 114 is larger than the air gap g₂ near the second surface 118. In one or more embodiments, a first thickness t₁ may be the same as or greater than a second thickness t₂, when the slant angle α gradually increases (i.e., α1<α2<α3). By varying the thickness t along its length, the effective permittivity ε′ at that location may be changed. By varying the slant angles α, the effective permittivity ε′ may be changed.

In one or more embodiments, when one or more of the thickness t or the slant angle α gradually change within a single antenna element, the gradient index and dielectric properties can be selectively tuned within the antenna structure. With a carefully designed gradient index, the antenna radiation pattern, coverage, and gain can be enhanced. An example of a gradient index is shown and described with respect to FIG. 13B.

FIG. 13B depicts a diagram of a gradient index 1300 generated using one or more embodiments of the low in-fill dielectric structure 110 with slanted laminae 1316 having one or more selected indices, in accordance with one or more embodiments. In an example, the structural properties, such as the slant angle α, the thickness t, the pitch size p′, the selected bulk printed material properties, other properties, or any combination thereof may be varied to provide a selected effective permittivity ε′. In this example, the effective permittivity ε′ varies from 1.1 at a center of the gradient index 1300 to 1.7 at the periphery of the gradient index 1300.

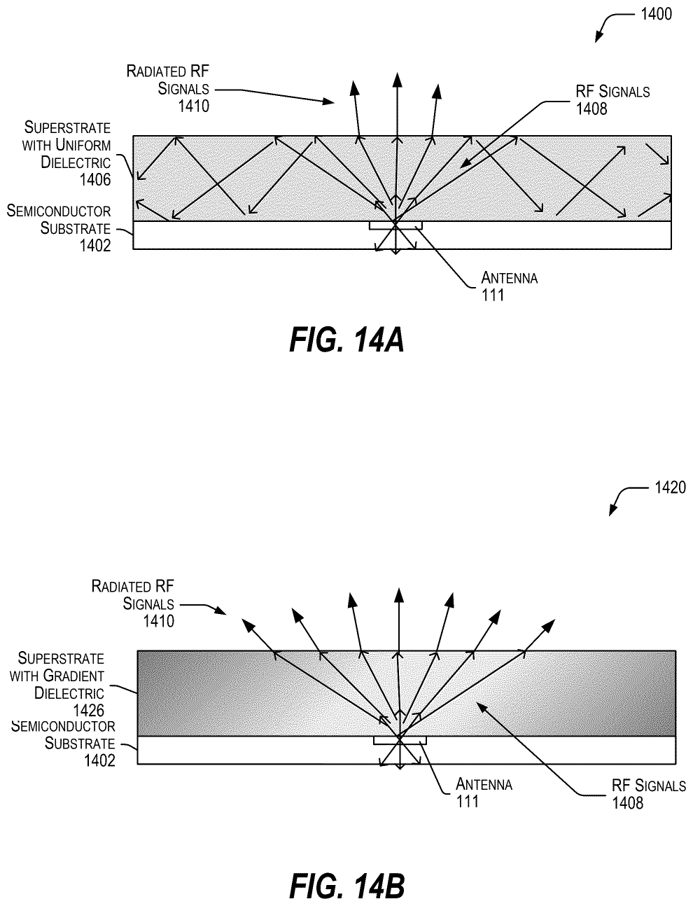

In one or more embodiments, the low in-fill dielectric structure 110 may be created with a selected gradient index that may be positioned on top of an antenna as a superstrate. Examples of such structures are described below with respect to FIGS. 14A and 14B.

FIG. 14A depicts a cross-sectional diagram of a portion of an antenna device 1400 including a superstrate 1406 over the antenna 111 that is formed from a low in-fill dielectric structure 110 having a uniform dielectric constant, in accordance with one or more embodiments. In this example, the antenna 111 may be coupled to a semiconductor substrate 1402, which may be an embodiment of the semiconductor substrate 102 in FIG. 1A. The antenna 111 may be electrically coupled to one or more metal layers (not shown) within the semiconductor substrate 1402.

The antenna 111 may be configured to emit radio frequency (RF) signals 1408 into the superstrate 1406 and into the semiconductor substrate 1402. In one or more embodiments, the semiconductor substrate 1402 may include a ground plane that may be configured to reflect or redirect in their intended direction those RF signals that are radiated toward the semiconductor substrate 1402. The RF signals 1408 that are emitted by the antenna 111 into the superstrate 1406 may be reflected by the surfaces of the superstrate 1406, causing interference and reducing the overall efficiency of the antenna device 1400.

FIG. 14B depicts a cross-sectional diagram of a portion of an antenna device 1420 including a superstrate 1426 over the antenna 111 that is formed from a low in-fill dielectric 110 having a dielectric constant that varies according to a gradient index, in accordance with one or more embodiments. In this example, the gradient index has a distribution of the effective permittivity ε′ that decreases from the center outward, assuming the angle of incidence is zero at the center (RF signal is received or sent at an angle that is perpendicular to the surface). In this example, the angle of incidence increases from the center outward. Accordingly, the signals impinging the surface of the superstrate 1426 at angles will be allowed to pass, reducing reflections. This gradient index of the effective permittivity ε′ (gradient dielectric constant) may increase the antenna gain. In one or more embodiments, the directionality of the low-fill geometry may affect the uniformity of the angular behavior of the RF signal, i.e., if the signal path runs more parallel to the laminae 116 instead of perpendicular, the dielectric may be affected by the orientation of the structure as well as the volume fraction.

In one or more embodiments, the superstrate 1406 in FIG. 14A and the superstrate 1426 in FIG. 14B may be alternative implementations of the low in-fill dielectric structure 110 in FIGS. 1A-3A, 4A-5A, 6A-6B, 8A-8B, 10A-10B, and 13A.

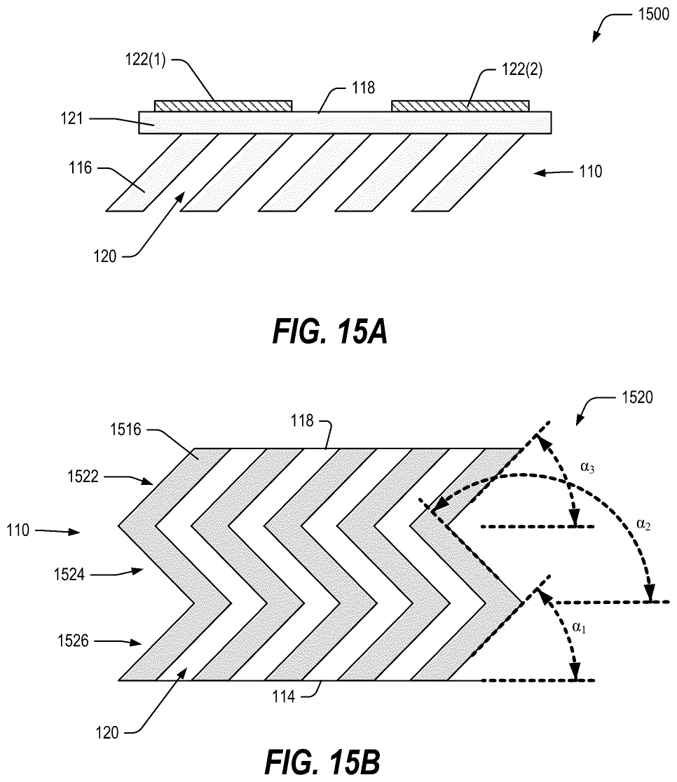

FIG. 15A depicts a cross-sectional view of a portion of an antenna device 1500 including a low in-fill dielectric 110 formed from slanted laminae 116 (or 1316) with a flat cap layer 121 for antenna placement, in accordance with one or more embodiments. In this example, the low in-fill dielectric structure 110 includes a plurality of laminae 116 or 1316 separated by air gaps 120. A second surface 118 is formed by the flat cap layer 121. In this example, parasitic antennas 122(1) and 122(2) may be mounted to the second surface 118 on the flat cap layer 121.

In one or more embodiments, the flat cap layer 1502 may facilitate coupling of the parasitic antennas 122 to the low in-fill dielectric structure 110. In one or more embodiments, the flat cap layer 1502 may increase the structural stability of the low in-fill dielectric structure 110, enabling coupling of the parasitic patch antenna 122 with low warpage.

While the examples of FIGS. 1A-3A, 4A-5A, 6A-6B, 8A-8B, 10A-10B, and 13A depicted slanted laminae 116 and the tapered laminae 1316 in FIG. 13A, it should be appreciated that the laminae may be produced with different shapes. For example, the laminae 116 or 1316 may have a zig-zag shape, a serpentine shape, or another shape that can be produced by the additive manufacturing processes and that can provide one or more of a gradient index or a selected effective permittivity ε′ across the low in-fill dielectric. An example of a stacked zig-zag structure is described below with respect to FIG. 15B.

FIG. 15B depicts a cross-sectional view of a portion of a device 1520 including a low in-fill dielectric structure 110 including a plurality of laminae 1516 having a zig-zag pattern, in accordance with one or more embodiments. Each laminar structure 1516 may be spaced apart from adjacent laminae 1516 air gaps 120.

Each laminar structure 1516 may include a first portion 1526 that may be near a first surface 114, a third portion 1522 that may be near a second surface 118, and a second portion 1524 that may extend between the first portion 1526 and the second portion 1522. The first portion 1526 and the third portion 1522 may extend at a first slant angle α₁, the second portion 1524 may extend at a second slant angle α₂ (which is larger than the first slant angle α₁), and the third portion 1522 may extend at a third slant angle α₃ (which may be the same as or different from the first slant angle α₁). In this example, the first slant angle α₁ and the third slant angle α₃ are the same.

In one or more embodiments, the first slant angle α₁ and the third slant angle α₃ may be different. In one or more embodiments, the slant angles α of one or more of the laminae 1516 may vary from the others to provide a selected gradient index. In one or more embodiments, the thickness t of one or more of the laminae 1516 or of one or more portions 1522, 1524, or 1526 of one or more of the laminae 1516 may vary to provide a selected gradient index.

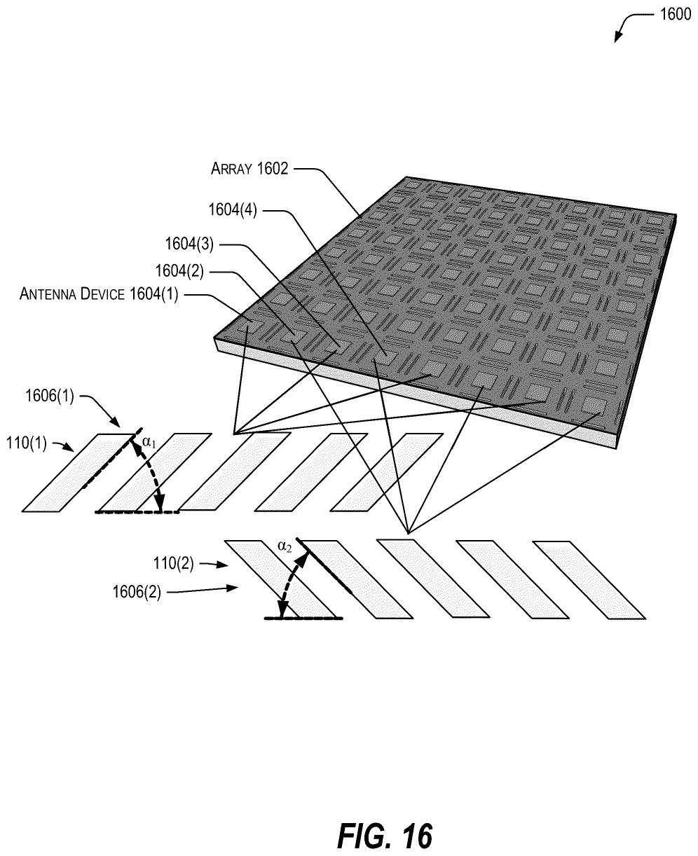

In one or more embodiments, multiple low in-fill dielectric structures 110 (uniform effective permittivity ε′, gradient index, or a combination thereof) may be incorporated in an antenna array. In one or more embodiments, each low in-fill dielectric structure 110 may include a selected uniform effective permittivity ε′, and the antenna array may include multiple antennas, each of which may include one of multiple selected effective permittivities ε′. In one or more embodiments, each low in-fill dielectric structure 110 may include a selected effective permittivity ε′ or a gradient index providing a selected gradient effective permittivity ε′. Multiple antenna devices including different low in-fill dielectric structures 110 may be included in the antenna array. In another example, an antenna system may include one or more a first antenna devices and one or more second antenna devices. The first antenna devices may include a first low in-fill dielectric structure 110 including laminae 116 having one or more first thicknesses t₁ and one or more first slant angles α₁. The second antenna devices may include a second low in-fill dielectric structure 110 including laminae 116 having one or more second thicknesses t₂ and one or more second slant angles α₂. An example of such a structure is described with respect to FIG. 16 below.

FIG. 16 depicts a diagram 1600 of an antenna array 1602 including multiple antenna devices 1604 having a low in-fill dielectric laminae 1606(1) with a first slant angle α₁ for a first subset of the antenna devices 1604(1) and 1604(3) and having a low in-fill dielectric laminae 1606(2) with a second slant angle α₂ for a second subset of the antenna devices 1604(2) and 1604(4), in accordance with one or more embodiments. The antenna devices 1604 may be embodiments of the substrate-based antenna device 100 in FIG. 1 and may incorporate any of the low in-fill dielectric structures 100 described above. In the illustrated embodiment, the laminae 1606 may have a selected slant angle α and a selected thickness t to provide a uniform effective permittivity ε′. In one or more embodiments, the slant direction of adjacent antenna devices 1604 may be varied to provide better mechanical strength.

In one or more embodiments, the slant angles α of the laminae 1604 may varied from one antenna device 1604 to another antenna device 1604 within the array 1602 to provide a selected variation in the effective permittivity ε′, for example, to provide a desired directionality or gradient index across the array 1602. In one or more embodiments, the slant angles α or the thicknesses t of the laminae 1604 may vary within a single antenna device 1604, across the array 1602 of antenna devices 1604, or any combination thereof. In one or more embodiments, each of the antenna devices 1604 may have a gradient index, and the gradient indices may vary across the array 1602.

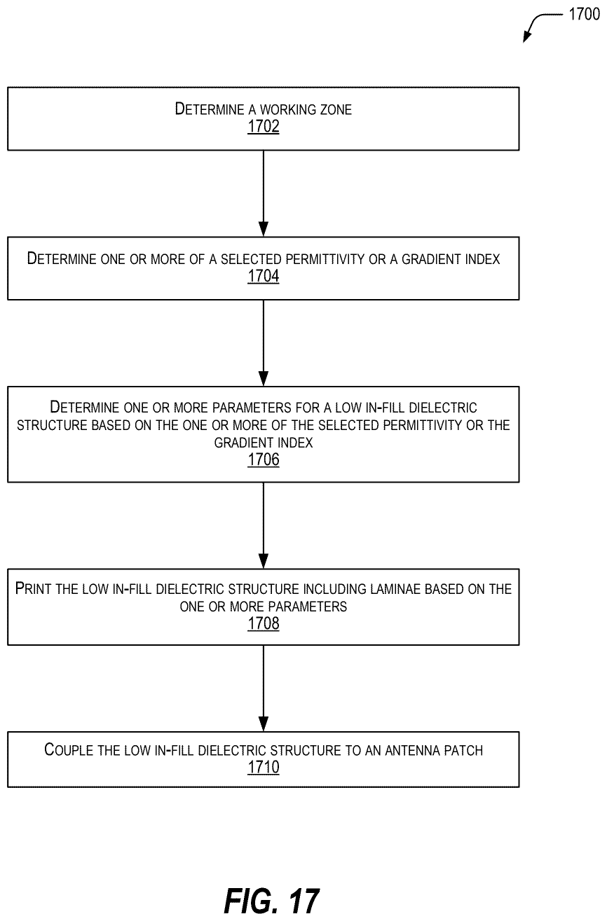

FIG. 17 depicts a flow diagram of a method 1700 of forming an antenna circuit including a low in-fill dielectric structure 110 having selected parameters, in accordance with one or more embodiments. At 1702, the method 1700 may include determining a working zone. As discussed above, the additive manufacturing process equipment and the bulk printed material may impose limitations on the slant angle α, thickness t, and air gap g based on the bulk print material properties and based on process limits, which may define a working zone that constrains one or more parameters to those that can be manufactured reliably to provide a selected effective permittivity ε′ or a gradient index.

At 1704, the method 1700 may include determining one or more of a selected effective permittivity ε′ or a gradient index. In one or more embodiments, a selected effective permittivity ε′ is selected when a uniform dielectric constant is to be produced across the low in-fill dielectric structure 110. In contrast, if the effective permittivity ε′ is to vary across the low in-fill dielectric structure, a gradient index may be determined. The gradient index may define a spatially varying gradient such that one or more locations along a length and width of a low in-fill dielectric structure 110 has a different effective permittivity ε′.

At 1706, the method 1700 may include determining one or more parameters for a low in-fill dielectric structure 110 based on the one or more of the selected permittivity or the gradient index. If the parameters are selected for a uniform effective permittivity ε′, the parameters may include one or more of a slant angle α or a thickness t. If the parameters are determined for the gradient index, one or more of a slant angle α, a thickness t, or a spatially varying thickness t′ may be selected for each location of a plurality of locations to produce a spatially variable effective permittivity ε′ for the low in-fill dielectric structure 110.

At 1708, the method 1700 may include printing the low in-fill dielectric structure 110 including laminae 116 or 1316 based on the one or more parameters. The low in-fill dielectric structure 110 may be printed directly onto the semiconductor substrate 102 or 1402 or may be printed separately and coupled to the semiconductor substrate 102 or 1402.

At 1710, the method 1700 may include coupling the low in-fill dielectric structure 110 to a patch antenna. In one or more embodiments, the patch antenna may include one or more of a driving patch antenna 111 or a parasitic patch antenna 122.

Features of one or more embodiments described herein may be understood by way of one or more of the following examples.

Example 1: An antenna circuit 100 may include a dielectric structure 110 including a first surface 112; a second surface 118; and a plurality of laminae 116 extending between the first surface 112 and the second surface 118, each lamina 116 including at least one thickness parameter t defining a thickness of each lamina 116 from a first end at the first surface to a second end at the second surface; at least one slant parameter α defining an angle between each lamina 116 and one or more of the first surface 112 or the second surface 118; and at least one pitch parameter p′ defining an air gap g between each lamina 116 and one or more adjacent laminae 116 of the plurality of laminate; where each of the plurality of laminae is configured at least partially overlap the one or more adjacent laminae in a direction that is perpendicular to the first and second surfaces; and a first patch antenna 111 disposed on the first surface 112; and where the dielectric structure 110 provides a selected effective permittivity ε′ for radio frequency signals from the first patch antenna 111 in the direction that is perpendicular to the first and second surfaces.

Example 2: The antenna circuit 100 of Example 1, further including a second patch antenna 122 disposed on the second surface 118, the second patch antenna 122 configured to resonate with the radio frequency signals received from the first patch antenna 111 through the dielectric structure 110.

Example 3: The antenna circuit of any of Examples 1 or 2, where one or more of the at least one slant angle or the at least one thickness are selected to be within a range of values constrained by limits of a manufacturing process.

Example 4: The antenna circuit of Example 3, where the range of values includes a range of slant angles that are greater than or equal to forty degrees and less than or equal to sixty-three degrees.

Example 5: The antenna circuit of Example 3, where the range of values includes a range of thicknesses that are greater or equal to than ninety-five micrometers and less than or equal to two hundred fifty-five micrometers.

Example 6: The antenna circuit of any of Examples 1-5, where, at any location, a line intersecting the first surface and the second surface at a perpendicular angle intersects at least one air gap and at least one of the plurality of laminae.

Example 7: The antenna circuit of Example 6, where the line intersects a first laminae and a second laminae of the plurality of laminae at a first location defining a first laminae depth corresponding to a depth of the first laminae where the line intersects and a second laminae depth corresponding to a depth of the second laminae where the line intersects, a first total laminae depth corresponds to a sum of the first laminae depth and the second laminae depth; the line insects a first air gap of the at least one air gap; a second line intersects the second laminae and a third laminae of the plurality of laminae at a second location defining a third laminae depth corresponding to a depth of the second laminae where the second line intersects and a fourth laminae depth corresponding to a depth of the third laminae where the second line intersects, a second total laminae depth corresponds to a sum of the third laminae depth and the fourth laminae depth; and the first laminae depth and the second laminae depth are equal within a range of manufacturing tolerances.

Example 8: The antenna circuit of any of Examples 1-7, where one or more of the slant angle or the thickness determines a size of the air gap.

Example 9: The antenna circuit of any of Examples 1-8, where the selected effective permittivity is inversely proportional to the size of the air gap for the radio frequency signals.

Example 10: The antenna circuit of any of Examples 1-9, where a first laminae of the plurality of laminae includes a first slant angle; and a second laminae of the plurality of laminae includes a second slant angle; and where the first slant angle is smaller than the second slant angle.

Example 11: The antenna circuit of any of Examples 1-10, where the selected effective permittivity for the radio frequency signals includes a uniform effective permittivity within a range of manufacturing tolerances.

Example 12: The antenna circuit of any of Examples 1-11, where the selected effective permittivity includes spatially varying effective permittivity for the radio frequency signals.

Example 13: The antenna circuit of Example 12, where the spatially varying effective permittivity is tuned to provide a gradient of effective permittivies across the plurality of laminae to provide an increased gain relative to a uniform effective permittivity for the radio frequency signals.

Example 14: A method may include forming a first planar layer of dielectric material on a circuit substrate, the first planar layer extending over a driving patch antenna of the circuit substrate; forming a laminar structure of the dielectric material on the first planar layer, the laminar structure including a plurality of laminae, each lamina having a selected thickness and a selected height, each lamina extending from a first end at the first planar layer to a second end and at a selected slant angle relative to the first planar layer, each lamina spaced apart from adjacent laminae of the plurality of laminae by a selected pitch size, and each lamina overlapping with at least one adjacent laminae of the plurality of laminae in a direction that is perpendicular to the first planar layer; forming a second planar layer on the laminar structure that is parallel to the first planar layer, the second planar layer extending over the plurality of laminae and coupled to the second end of each lamina; and providing a parasitic patch antenna on the second planar layer and aligned with the driving patch antenna; and where the plurality of laminae, the first planar layer, and the second planar layer present a selected effective permittivity for radio frequency signals between the driving patch antenna and the parasitic patch antenna and at an angle that is perpendicular to the first planar layer and the second planar layer.

Example 15: The method of Example 14, where forming the laminar structure includes selectively varying one or more of the selected thickness or the selected slant angle of one or more of the plurality of laminae to vary the selected effective permittivity for the radio frequency signals; and forming one or more first laminae of the plurality of laminae based on the selected thickness and the selected slant angle; and forming one or more second laminae of the plurality of laminae based on the selectively varied one or more of the selected thickness or the selected slant angle.

Example 16: The method of any of Examples 14 or 15, where the selected slant angle is within a range of slant angles that are greater than or equal to forty degrees and less than or equal to sixty-three degrees.

Example 17: The antenna circuit of any of Examples 14-16, where the selected thickness is within a range of thicknesses that are greater or equal to than ninety-five micrometers and less than or equal to two hundred fifty-five micrometers.

Example 18: The antenna circuit of any of Examples 14-17, where the selected effective permittivity for the radio frequency signals includes a uniform effective permittivity within a range of manufacturing tolerances.

Example 19: The antenna circuit of any of Examples 14-18, where the selected effective permittivity includes spatially varying effective permittivity for the radio frequency signals.

Example 20: The antenna circuit of Example 19, where the spatially varying effective permittivity is tuned to provide a gradient of effective permittivies across the plurality of laminae to provide an increased gain relative to a uniform effective permittivity for the radio frequency signals.

In one or more embodiments, an antenna circuit may include a patch antenna and a low in-fill dielectric structure coupled to the patch antenna. The low in-fill dielectric structure may include a first surface coupled to the patch antenna; a second surface; and a plurality of laminae extending between the first surface and the second surface. Each laminar structure may extend at a slant angle relative to the first surface, may have a thickness, and may be separated from an adjacent laminar structure by an air gap. The plurality of laminae may have a pitch size such that each laminar structure at least partially overlaps adjacent laminae. The low in-fill dielectric structure may provide a selected effective permittivity. The selected effective permittivity may vary from antenna circuit to antenna circuit within an array. The selected effective permittivity may be uniform or may provide a selected gradient index.

The preceding detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

The connecting lines shown in the various figures contained herein are intended to represent exemplary functional relationships and/or physical couplings between the various elements. It should be noted that many alternative or additional functional relationships or physical connections may be present in one or more embodiments of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

The foregoing description refers to elements or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematic shown in the figures depict one exemplary arrangement of elements, additional intervening elements, devices, features, or components may be present in one or more embodiments of the depicted subject matter.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims.

What is claimed is:

1. An antenna circuit comprises:
a dielectric structure comprising:
a first surface;
a second surface; and
a plurality of laminae extending between the first surface and the second surface, each lamina includes:
at least one thickness parameter defining a thickness of each lamina from a first end at the first surface to a second end at the second surface;
at least one slant parameter defining an angle between each lamina and one or more of the first surface or the second surface; and
at least one pitch parameter defining an air gap between each lamina and one or more adjacent laminae of the plurality of laminate;
wherein each of the plurality of laminae is configured at least partially overlap the one or more adjacent laminae in a direction that is perpendicular to the first and second surfaces; and
a first patch antenna disposed on the first surface; and
wherein the dielectric structure provides a selected effective permittivity for radio frequency signals from the first patch antenna in the direction that is perpendicular to the first and second surfaces.

2. The antenna circuit of claim 1, further comprising a second patch antenna disposed on the second surface, the second patch antenna configured to resonate with the radio frequency signals received from the first patch antenna through the dielectric structure.

3. The antenna circuit of claim 1, wherein one or more of the at least one slant angle or the at least one thickness are selected to be within a range of values constrained by limits of a manufacturing process.

4. The antenna circuit of claim 3, wherein the range of values includes a range of slant angles that are greater than or equal to forty degrees and less than or equal to sixty-three degrees.

5. The antenna circuit of claim 3, wherein the range of values includes a range of thicknesses that are greater or equal to than ninety-five micrometers and less than or equal to two hundred fifty-five micrometers.

6. The antenna circuit of claim 1, wherein, at any location, a line intersecting the first surface and the second surface at a perpendicular angle intersects at least one air gap and at least one of the plurality of laminae.

7. The antenna circuit of claim 6, wherein:
the line intersects a first laminae and a second laminae of the plurality of laminae at a first location defining a first laminae depth corresponding to a depth of the first laminae where the line intersects and a second laminae depth corresponding to a depth of the second laminae where the line intersects, a first total laminae depth corresponds to a sum of the first laminae depth and the second laminae depth;
the line insects a first air gap of the at least one air gap;
a second line intersects the second laminae and a third laminae of the plurality of laminae at a second location defining a third laminae depth corresponding to a depth of the second laminae where the second line intersects and a fourth laminae depth corresponding to a depth of the third laminae where the second line intersects, a second total laminae depth corresponds to a sum of the third laminae depth and the fourth laminae depth; and
the first laminae depth and the second laminae depth are equal within a range of manufacturing tolerances.

8. The antenna circuit of claim 1, wherein one or more of the slant angle or the thickness determines a size of the air gap.

9. The antenna circuit of claim 1, wherein the selected effective permittivity is inversely proportional to the size of the air gap for the radio frequency signals.

10. The antenna circuit of claim 1, wherein:
a first laminae of the plurality of laminae includes a first slant angle; and
a second laminae of the plurality of laminae includes a second slant angle; and
wherein the first slant angle is smaller than the second slant angle.

11. The antenna circuit of claim 1, wherein the selected effective permittivity for the radio frequency signals comprises a uniform effective permittivity within a range of manufacturing tolerances.

12. The antenna circuit of claim 1, wherein the selected effective permittivity comprises spatially varying effective permittivity for the radio frequency signals.

13. The antenna circuit of claim 12, wherein the spatially varying effective permittivity is tuned to provide a gradient of effective permittivies across the plurality of laminae to provide an increased gain relative to a uniform effective permittivity for the radio frequency signals.

14. A method comprising:
forming a first planar layer of dielectric material on a circuit substrate, the first planar layer extending over a driving patch antenna of the circuit substrate;
forming a laminar structure of the dielectric material on the first planar layer, the laminar structure including a plurality of laminae, each lamina having a selected thickness and a selected height, each lamina extending from a first end at the first planar layer to a second end and at a selected slant angle relative to the first planar layer, each lamina spaced apart from adjacent laminae of the plurality of laminae by a selected pitch size, and each lamina overlapping with at least one adjacent lamina of the plurality of laminae in a direction that is perpendicular to the first planar layer;
forming a second planar layer on the laminar structure that is parallel to the first planar layer, the second planar layer extending over the plurality of laminae and coupled to the second end of each lamina;
providing a parasitic patch antenna on the second planar layer and aligned with the driving patch antenna; and
wherein the plurality of laminae, the first planar layer, and the second planar layer present a selected effective permittivity for radio frequency signals between the driving patch antenna and the parasitic patch antenna and at an angle that is perpendicular to the first planar layer and the second planar layer.

15. The method of claim 14, wherein forming the laminar structure comprises:
selectively varying one or more of the selected thickness or the selected slant angle of one or more of the plurality of laminae to vary the selected effective permittivity for the radio frequency signals;
forming one or more first laminae of the plurality of laminae based on the selected thickness and the selected slant angle; and
forming one or more second laminae of the plurality of laminae based on the selectively varied one or more of the selected thickness or the selected slant angle.

16. The method of claim 14, wherein the selected slant angle is within a range of slant angles that are greater than or equal to forty degrees and less than or equal to sixty-three degrees.

17. The antenna circuit of claim 14, wherein the selected thickness is within a range of thicknesses that are greater or equal to than ninety-five micrometers and less than or equal to two hundred fifty-five micrometers.

18. The antenna circuit of claim 14, wherein the selected effective permittivity for the radio frequency signals comprises a uniform effective permittivity within a range of manufacturing tolerances.

19. The antenna circuit of claim 14, wherein the selected effective permittivity comprises spatially varying effective permittivity for the radio frequency signals.

20. The antenna circuit of claim 19, wherein the spatially varying effective permittivity is tuned to provide a gradient of effective permittivies across the plurality of laminae to provide an increased gain relative to a uniform effective permittivity for the radio frequency signals.
